(19) United States
(12) Patent Application Publication
(10) Pub. No.: US 2023/0247746 A1
(43) Pub. Date: Aug. 3, 2023

(54) ACTIVE SENSING CONTROL MODULE FOR ENVIRONMENTAL FEATURES

(71) Applicant: SKYTECH ELECTRONIC TECHNOLOGY LIMITED COMPANY, SHENZHEN CITY, GUANGDONG PROVINCE (CN)

(72) Inventor: JIANPING WANG, SHENZHEN CITY, GUANGDONG PROVINCE (CN)

(21) Appl. No.: 17/784,083

(22) PCT Filed: Jan. 19, 2021
(86) PCT No.: PCT/CN2021/072709

§ 371 Date: Jun. 9, 2022

(51) Int. Cl. H05B 47/165; H05B 47/12; H05B 47/125; G10K 15/02

(52) U.S. Cl. CPC H05B 47/165; H05B 47/12; H05B 47/125; G10K 15/02

(57) ABSTRACT

The present disclosure is related to relates to the field of scene control, and an active sensing control module for environmental features is provided, including a first storage unit storing a sound feature template, a second storage unit storing a light feature template, a sound pickup, a an image sensor and a processor, wherein the processor is configured to receive output data of the sound pickup, compare the output data of the sound pickup with the sound feature template and output a first control signal at the same time, and to receive output data of the image sensor, compare the output data of the image sensor with the light feature template and output a second control signal at the same time.

### FIELD OF THE DISCLOSURE

The present disclosure relates to the technical field of scene control, and, in particular, to an active sensing control module for environmental features.

### BACKGROUND OF THE DISCLOSURE

In large-scale events, festivals and other events, such as Halloween and Christmas, interactive activities are often designed to render the festive atmosphere. For example, when there are sounds such as ghost sounds, ghost laughter, Trick or Treat, etc. at a Halloween event, or when there is a white flash of lightning (two warm white flashes in a second), a two-second orange-blue change color time, while there are sounds of Santa's “squeaky” laughter, Merry Christmas, jingle bell sounds, flashes of warm white light within two seconds per second, or when there are two flashes of warm white light within one second and changing colors of red and green for two seconds, the props on the scene will produce some kind of light and shadow effect or motion effect.

Currently, this type of interaction is controlled manually, which wastes a lot of manpower.

### SUMMARY OF THE DISCLOSURE

The purpose of the present disclosure is to provide an active sensing control module for environmental features to overcome the aforementioned technical defects.

For reaching the above-mentioned purpose, the technical solutions adopted in the present disclosure are as follows.

An active sensing control module for environmental features is provided, including a first storage unit storing a sound feature template, a second storage unit storing a light feature template, a sound pickup, a an image sensor and a processor, wherein the processor is configured to receive output data of the sound pickup, compare the output data of the sound pickup with the sound feature template and output a first control signal at the same time, and to receive output data of the image sensor, compare the output data of the image sensor with the light feature template and output a second control signal at the same time.

Preferably, the light feature template includes one or more of color features, frequency features, and color and frequency combination features.

Preferably, the image sensor includes a complementary metal oxide semiconductor sensor.

Preferably, the image sensor includes a charge coupled device sensor.

Preferably, the first storage unit, the second storage unit, the sound pickup, the image sensor and the processor are integrated on a same circuit substrate, and the circuit substrate is further provided with at least one interface to transmit the first control signal and the second control signal to an outside.

Preferably, the circuit substrate is provided with multiple ones of the interfaces, and the interfaces are connected to the processor through a circuit with a routing function.

Compared with the prior art, the present disclosure has at least the following beneficial effects.

This module organically combines a sound pickup, an image sensor, a processor, a sound feature template memory, and a light feature template memory to detect the sound and light features in the environment, so that when a predetermined feature occurs, the corresponding control signal is automatically output to embody automatic control based on the sound and light features of the environment.

### BRIEF DESCRIPTION OF THE DRAWINGS

FIG. 1 is a block diagram of an active sensing control module for environmental features.

Reference numeral: 1. sound pickup; 2. image sensor; 3. first storage unit; 4. processor; 5. second storage unit; 6. routing circuit; 7. interface.

### DETAILED DESCRIPTION OF THE EXEMPLARY EMBODIMENTS

The present disclosure will be further described below with reference to the accompanying drawings and embodiments.

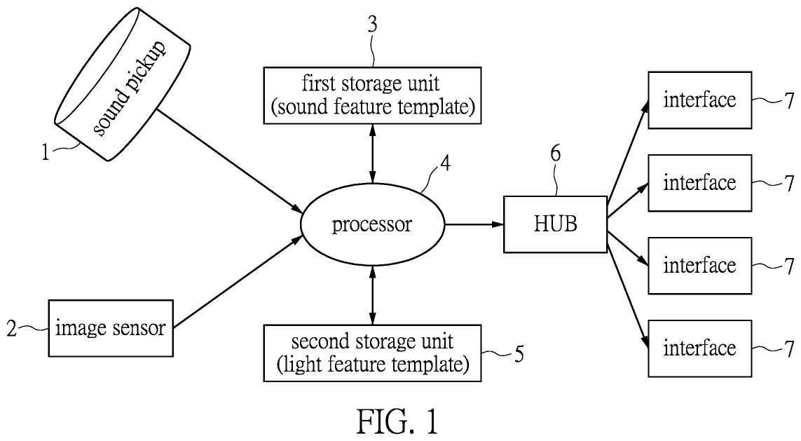

Reference is made to FIG. 1. The active sensing control module for environmental features includes: a first storage unit 3 storing a sound feature template, a second storage unit 5 storing a light feature template, a sound pickup 1, an image sensor 2 and a processor 4. The processor 4 is connected with the first storage unit 3, the second storage unit 5, the sound pickup 1 and the image sensor 2, and the processor 4 is configured to receive output data of the sound pickup 1 and compare the output data of the sound pickup 1 with the sound feature template and output a first control signal at the same time, and to receive output data of the image sensor 2, compare the output data of the image sensor with the light feature template and output a second control signal at the same time. Here, the first storage unit 3 and the second storage unit 5 that can be used include but are not limited to read-only memory (Read-Only Memory, ROM), random access memory (Random Access Memory, RAM), electrified erasable programmable only memory Read memory (Electrically Erasable Programmable read only memory, EEPROM), flash memory (flash memory). The processor 4 that can be used includes, but is not limited to, a central processing unit (CPU, Central Processing Unit), a microprocessor (MCU), a graphics processing unit (Graphics Processing Unit, GPU), and a digital signal processor (Digital Signal Process, DSP). The image sensor 2 is preferably a complementary metal oxide semiconductor (Complementary Metal Oxide Semiconductor, CMOS) sensor, or a charge-coupled device (charge-coupled device, CCD) sensor.

The sound feature template in the first storage unit 3 is specifically set according to actual application scenarios, and one or more sound feature templates may be set. For example, when applied to the Chinese Spring Festival, the sound feature template can be set to sounds like “Happy New Year”, “New Year's greetings”, etc. When applied to Christmas, the sound feature templates can be set to “Santa's squeaky laughter”, “Merry Christmas”, “jingle bell sounds” and other sounds, when applied to Halloween, the sound feature template can be set to ghost sounds, ghost laughter, Trick or Treat and other sounds.

The light feature templates in the second storage unit 5 are also specifically set according to actual application scenarios, and one or more light feature templates may be set. The features that can be employed by the light feature template are preferably, but not limited to, color features, frequency features, or a combination thereof. For example, when applied to Christmas, the light feature template can be set to appear within two flashes of warm white light within a second, or a changing color between red and green for two seconds. When applied to Halloween, the light feature template can be set to appear as a white flash of lightning (two warm white flashes in a second), or a changing color of orange and blue for two seconds.

Reference is made to FIG. 1 again. The active sensing control module for environmental features includes: a plurality of interfaces 7 and a routing circuit 6, and the plurality of the interfaces 7 are connected to the processor 4 through the routing circuit 6. Different controlled devices can be connected to multiple interfaces 7 to realize control of multiple devices. The available interfaces 7 include but are not limited to Universal Serial Bus (USB), RS-232 serial interface, RS485 serial interface, Ethernet interface (such as SC fiber interface, RJ-45 interface), wireless Network interface (such as Wi-Fi, 3G, 4G, 5G, etc.), etc.

Preferably, the first storage unit 3, the second storage unit 5, the sound pickup 1, the image sensor 2, the processor 4, the interface 7, and the routing circuit 6 are integrated on the same circuit substrate.

It can be seen that this module organically combines the sound pickup 1, the image sensor 2, the processor 4, the sound feature template memory, the light feature template memory, the interface 7, and the routing circuit 6, and can actively collect the sound and light signals in the environment. After the template is the same as the predetermined signal, it can actively generate and output control signals, which can be applied to the on-site control of large-scale events and festivals, and embody automatic control based on environmental features.

The present disclosure has been described in detail above through specific embodiments. These detailed descriptions are only intended to help those skilled in the art to understand the content of the present disclosure, and should not be construed as limiting the protection scope of the present disclosure. Various modifications, equivalent transformations, etc. performed by those skilled in the art on the above solutions under the concept of the present disclosure shall be included in the protection scope of the present disclosure.

1. An active sensing control module for environmental features, including a first storage unit storing a sound feature template, a second storage unit storing a light feature template, a sound pickup, a an image sensor and a processor, wherein the processor is configured to receive output data of the sound pickup, compare the output data of the sound pickup with the sound feature template and output a first control signal at the same time, and to receive output data of the image sensor, compare the output data of the image sensor with the light feature template and output a second control signal at the same time;
wherein the sound feature template includes at least one of: a sound suitable for the Chinese Spring Festival greeting, a sound suitable for Christmas, and a sound suitable for Halloween, wherein the sound suitable for the Chinese New Year greeting includes a greeting for Happy Chinese New Year; the sound suitable for Christmas includes a Santa's “squeaky” laughter, a Merry Christmas sound and a jingle bell sound; and the sound suitable for Halloween includes a ghost sound, a ghost laughter, Trick or Treat sounds; and
wherein the light feature template includes at least one of: a light feature suitable for Christmas and a light feature suitable for Halloween, wherein the light feature suitable for Christmas includes warm white flashes that occur within two times in one second, or a changing color between red and green for two seconds; the light feature suitable for Halloween includes a white flash of lightning, or a changing color between orange and blue for two seconds.

2. The active sensing control module for environmental features according to claim 1, wherein the light feature template includes one or more of color features, frequency features, and color and frequency combination features.

3. The active sensing control module for environmental features according to claim 1, wherein the image sensor includes a complementary metal oxide semiconductor sensor.

4. The active sensing control module for environmental features according to claim 1, wherein the image sensor includes a charge coupled device sensor.

5. The active sensing control module for environmental features according to claim 1, wherein the first storage unit, the second storage unit, the sound pickup, the image sensor and the processor are integrated on a same circuit substrate, and the circuit substrate is further provided with at least one interface to transmit the first control signal and the second control signal to an outside.

6. The active sensing control module for environmental features according to claim 5, wherein the circuit substrate is provided with multiple ones of the interfaces, and the interfaces are connected to the processor through a circuit with a routing function.
